(19) United States
(12) Patent Application Publication
(10) Pub. No.: US 2021/0347424 A1
(43) Pub. Date: Nov. 11, 2021

(54) VEHICLE REMOTE CONTROL METHOD, VEHICLE REMOTE CONTROL SYSTEM, SERVER, IN-VEHICLE CONTROL DEVICE, VEHICLE, AND TERMINAL DEVICE

(71) Applicant: HONDA MOTOR CO., LTD., Tokyo (JP)

(72) Inventors: Yotaro Mori, Wako-shi (JP); Keisuke Kishikawa, Wako-shi (JP)

(73) Assignee: HONDA MOTOR CO., LTD., Tokyo (JP)

(21) Appl. No.: 17/382,545

(22) Filed: Jul. 22, 2021

Related U.S. Application Data
(63) Continuation of application No. PCT/JP2019/003519, filed on Jan. 31, 2019.

(51) Int. Cl. B62H 5/08; B62J 50/22; B62J 45/20; G05D 1/00

(52) U.S. Cl. CPC B62H 5/08; B62J 50/22; G05D 1/0016; G05D 1/0044; B62J 45/20

(57) ABSTRACT

There is provided a remote control method for a vehicle comprising, making a notification to a terminal device, acquiring open information representing that the notification is opened in the terminal device, and controlling transmission of a control signal for controlling actuation of the vehicle to the vehicle. In the controlling, the control signal is transmitted based on acquisition of the open information for the notification in the acquiring. The control signal is a signal for restricting starting of a power source of the vehicle.

### CROSS-REFERENCE TO RELATED APPLICATION

This application is a continuation of International Patent Application No. PCT/JP2019/003519 filed on Jan. 31, 2019, the entire disclosures of which are incorporated herein by reference.

### BACKGROUND OF THE INVENTION

### Field of the Invention

The present invention relates to a vehicle remote control method, a vehicle remote control system, a server, an in-vehicle control device, a vehicle, and a terminal device.

### Description of the Related Art

As one aspect of a vehicle sales service, there exists a service based on a loan contract (Japanese Patent No. 6238038). A user who has purchased a vehicle based on a loan contract needs to periodically pay money, and if the payment is delayed, the use of the vehicle by the user can be restricted. It can be considered that as a method of restricting the use of the vehicle, a signal for requesting the restriction is transmitted to the vehicle.

### SUMMARY OF THE INVENTION

According to one embodiment of the present invention, there is provided a remote control method for a vehicle comprising: making a notification to a terminal device; acquiring open information representing that the notification is opened in the terminal device; and controlling transmission of a control signal for controlling actuation of the vehicle to the vehicle, wherein in the controlling, the control signal is transmitted based on acquisition of the open information for the notification in the acquiring, and wherein the control signal is a signal for restricting starting of a power source of the vehicle.

According to another embodiment of the present invention, there is provided a vehicle remote control system comprising a server, a vehicle, and a terminal device, wherein the server comprises: a notification unit configured to make a notification to the terminal device; an acquisition unit configured to acquire open information representing that the notification is opened in the terminal device; and a transmission control unit configured to control transmission of a control signal for controlling actuation of the vehicle to the vehicle, wherein the transmission control unit transmits the control signal based on acquisition of the open information for the notification by the acquisition unit, and wherein the control signal is a signal for restricting starting of a power source of the vehicle.

According to still another embodiment of the present invention, there is provided a server capable of transmitting a control signal for remote-controlling a vehicle comprising: a notification unit configured to make a notification to a terminal device; an acquisition unit configured to acquire open information representing that the notification is opened in the terminal device; and a transmission control unit configured to control transmission of a control signal for controlling actuation of the vehicle to the vehicle, wherein the transmission control unit transmits the control signal based on acquisition of the open information for the notification by the acquisition unit, and wherein the control signal is a signal for restricting starting of a power source of the vehicle.

According to yet another embodiment of the present invention, there is provided an in-vehicle control device wherein the device can receive a control signal from a server according to the above embodiment and control actuation of a vehicle based on the received control signal.

According to still yet another embodiment of the present invention, there is provided a vehicle comprising an in-vehicle control device defined in the above embodiment.

According to yet still another embodiment of the present invention, there is provided a terminal device capable of receiving a notification from a server defined in the above embodiment comprising: a reception unit configured to receive the notification from the server; a display unit configured to be capable of displaying the notification; and a transmission unit configured to, if the display unit displays the notification, transmit, to the server, open information representing that the notification is opened.

According to yet still another embodiment of the present invention, there is provided a remote control method for a vehicle comprising: making a notification to a terminal device; acquiring information representing that the notification is displayed on a display unit of the terminal device; and controlling transmission of a control signal for controlling actuation of the vehicle to the vehicle, wherein in the controlling, the control signal is transmitted based on acquisition of the information representing that the notification is displayed in the acquiring, and wherein the control signal is a signal for restricting starting of a power source of the vehicle.

According to yet still another embodiment of the present invention, there is provided a vehicle remote control system comprising a server, a vehicle, and a terminal device, wherein the server comprises: a notification unit configured to make a notification to the terminal device; an acquisition unit configured to acquire information representing that the notification is displayed on a display unit of the terminal device; and a transmission control unit configured to control transmission of a control signal for controlling actuation of the vehicle to the vehicle, wherein the transmission control unit transmits the control signal based on acquisition of the information representing that the notification is displayed by the acquisition unit, and wherein the control signal is a signal for restricting starting of a power source of the vehicle.

According to yet still another embodiment of the present invention, there is provided a server capable of transmitting a control signal for remote-controlling a vehicle comprising: a notification unit configured to make a notification to a terminal device; an acquisition unit configured to acquire information representing that the notification is displayed on a display unit of the terminal device; and a transmission control unit configured to control transmission of a control signal for controlling actuation of the vehicle to the vehicle, wherein the transmission control unit transmits the control signal based on acquisition of the information representing that the notification is displayed by the acquisition unit, and wherein the control signal is a signal for restricting starting of a power source of the vehicle.

Further features of the present invention will become apparent from the following description of exemplary embodiments (with reference to the attached drawings).

### BRIEF DESCRIPTION OF THE DRAWINGS

FIG. 1 is a block diagram for explaining an example of a system formed by a vehicle, a user thereof, and a sales company;

FIG. 2 is a functional block diagram for explaining an example of the software configuration of a server;

FIG. 3 is a flowchart for explaining an example of remote control of a vehicle by a server according to the first embodiment;

FIG. 4 is a flowchart for explaining an example of remote control of a vehicle by a server according to the second embodiment; and

FIG. 5 is a flowchart for explaining an example of remote control of a vehicle by a server according to the third embodiment.

### DESCRIPTION OF THE EMBODIMENTS

In the conventional technique, a message representing that the use of the vehicle is restricted is transmitted to a terminal device held by the user, and after the elapse of a predetermined period, a signal for requesting the restriction is transmitted from a server to the vehicle. However, even if the message is transmitted, if the user does not confirm the message, the use of the vehicle may be restricted in a state in which the user does not recognize that the use of the vehicle is restricted.

An embodiment of the present invention executes restriction of use of a vehicle in a state in which a user recognizes it.

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

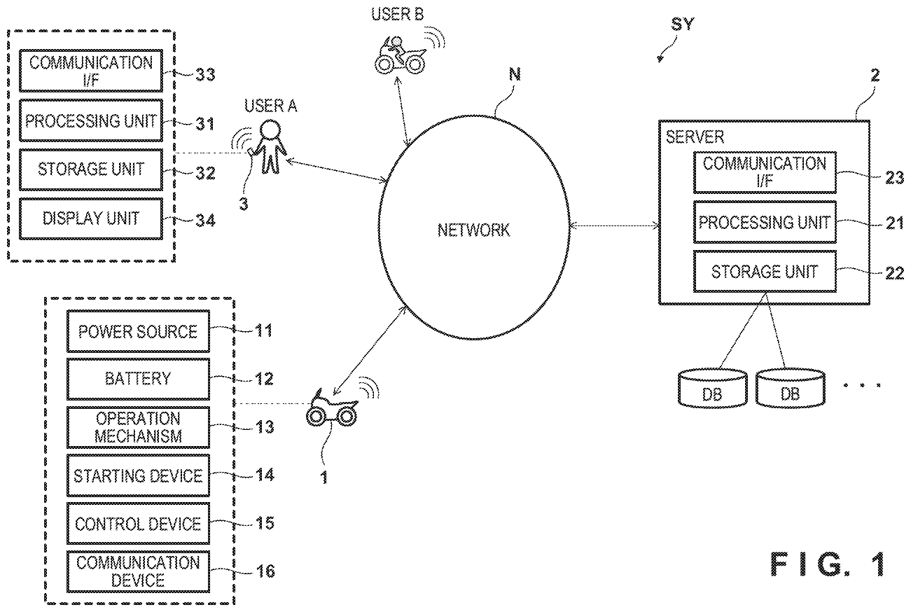

FIG. 1 shows an example of the configuration of a vehicle use service system SY (vehicle remote control system) according to the first embodiment. The system SY includes one or more vehicles 1, a terminal device 3 of users thereof (for example, users A and B), and a server 2 of a management company, which can communicate with these via a network N.

The vehicle 1 is a straddle type vehicle in this embodiment but may be a riding type vehicle as another embodiment. Note that the straddle type vehicle indicates a type that a driver rides while straddling the vehicle body, and the concept includes not only a typical motorcycle (including a scooter-type vehicle) but also a three-wheeled vehicle (a vehicle with one front wheel and two rear wheels or a vehicle with two front wheels and one rear wheel), and an all terrain vehicle (ATV) such as a four-wheeled buggy.

The vehicle 1 includes a power source 11, a battery 12, an operation mechanism 13, a starting device 14, a control device 15, and a communication device 16. In this embodiment, the power source 11 is an internal combustion engine (engine). However, as another embodiment, an electric motor such as a three-phase induction motor may be used as the power source 11. A secondary battery that can be charged based on the power of the power source 11 is used as the battery 12. Examples are a lead storage battery, a lithium ion battery, and a nickel hydrogen battery.

The operation mechanism 13 is configured to be able to input an operation for controlling the power source 11 and, for example, outputs a predetermined control signal to the control device 15 (to be described later) based on an operation input by the user A. Examples of the operation input to the operation mechanism 13 are a rotating operation using a predetermined key (an ignition key, a remote key, or the like) corresponding to the vehicle 1, and a pressing operation using a press type switch (a start switch, or the like).

Based on the operation input to the operation mechanism 13, the starting device 14 can start the power source 11 and set it in an operation state, and can also stop the power source 11 in the operation state. For the starting device 14, a cell switch, a kill switch, and a predetermined key are used.

As will be described later in detail, the control device 15 is an ECU (Electronic Control Unit) capable of performing operation control of the entire vehicle 1, and can, for example, transmit/receive signals to/from each constituent element of the vehicle 1 via predetermined signal lines. As an example, the control device 15 can receive a control signal according to an operation input to the operation mechanism 13 and cause the starting device 14 to start the power source 11.

The functions of the control device 15 can be implemented by either hardware or software. For example, the functions of the control device 15 may be implemented by executing a predetermined program by a CPU (Central Processing Unit) using a memory. Alternatively, the functions of the control device 15 may be implemented by a known semiconductor device such as a PLD (Programmable Logic Device) or an ASIC (Application Specific Integrated Circuit). The control device 15 is shown here as a single element. However, the control device 15 may be divided into two or more elements as needed.

The communication device 16 includes a TCU (Telematics Control Unit) that performs signal processing for performing communication with the network N, and the like. The TCU includes an antenna, and communication with the network N is implemented by the antenna. From the viewpoint of the control device 15, the control device 15 can communicate with the server 2 (to be described later) by the communication device 16 via the network N. Note that some of the functions of the TCU may be provided in the control device 15, and some of the functions of the control device 15 may be provided in the TCU.

In addition to the above-described components, the vehicle 1 may include, for example, meters capable of displaying various kinds of information such as a vehicle speed and an engine speed, an indicator configured to make a notification to the user, and the like. The vehicle 1 may also include an operation unit such as an operation button configured to change the display contents of a meter or turn off an indicator that has been lighted.

The server 2 includes a processing unit 21, a storage unit 22, and a communication interface unit 23 and can be installed in, for example, the office of a management company that provides a vehicle use service. The processing unit 21 is a processor including a CPU and a memory, and the storage unit 22 is an HDD (Hard Disk Drive) having a relatively large capacity. In addition, the storage unit 22 may be distributedly arranged on a cloud.

For example, the processing unit 21 can communicate with the vehicle 1 by the communication interface unit 23 via the network N, store information about the vehicle 1 in the storage unit 22, or read out the information from the storage unit 22. The processing unit 21 can also communicate with the terminal 3 (a portable terminal such as a smartphone) of the user A of the vehicle 1, store information about the user A in the storage unit 22, or read out the information from the storage unit 22. The information about the vehicle 1 and the information about the user A are associated with each other to form a database DB concerning the vehicle 1 and the user A. Similarly, the database DB is also formed even for each of the other user B during driving and other users (not shown).

In the vehicle use service system SY, the server 2 of the management company can communicate with the vehicle 1, the user A, and the like and perform predetermined management. Examples of the vehicle use service are a vehicle sales service and a vehicle rental service, and examples of the management by the management company are permission and restriction of use of the vehicle 1 for a user.

For example, in a case in which vehicle sales based on a loan contract is done between the management company and the user A, the server 2 of the management company can permit the user A to use the vehicle 1 while appropriate payment is being done by the user A and restrict the use if the payment is delayed. As an example, the server 2 manages the state of payment by the user A on the database DB. If the payment delays, the server 2 transmits a signal for requesting restriction of the use of the vehicle 1, for example, a signal for requesting restriction of the start of the power source 11 to the vehicle 1 of the user A. In the vehicle 1, in accordance with the reception of the signal from the server 2 by the communication device 16, the control device 15 can suppress the start of the power source 11 by the starting device 14.

The terminal 3 is a PC or a portable terminal such as a smartphone, which includes a processing unit 31, a storage unit 32, a communication interface unit 33, and a display unit 34 and is held by, for example, the user A. The processing unit 31 is a processor including a CPU and a main memory, and the storage unit 32 is, for example, a ROM that is a nonvolatile memory or an SD card that is an external memory.

The processing unit 31 can communicate with the server 2 by the communication interface unit 33 via the network N and read out information about the vehicle 1 or information about the user A himself/herself from the database DB of the server 2. For example, the user A can confirm the next day of loan payment, the loan balance, and the like. In addition, for example, the processing unit 31 can receive a notification for the user A by the communication interface unit 33 from the server 2 via the network N. The server 2, for example, notifies the terminal 3 of the state of loan payment by the user A, and the like. The display unit 34 is formed by, for example, a liquid crystal display or the like and displays a GUI (Graphical User Interface) or various kinds of information. When the display unit 34 displays a notification from the server 2, the user can confirm the contents.

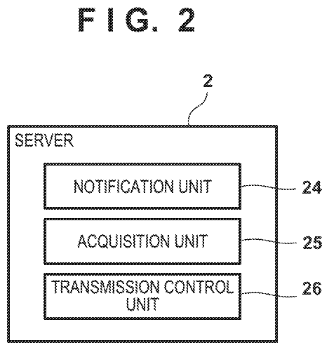

FIG. 2 is a functional block diagram for explaining an example of the software configuration of the server 2. For example, the processing unit 21 of the server 2 functions as the functional units shown in FIG. 2 when the CPU reads out a program stored in the storage unit 22 to the memory included in the processing unit 21 and executes. The server 2 includes a notification unit 24, an acquisition unit 25, and a transmission control unit 26. Note that the functional units are merely examples, and the functions of the functional units may be integrated, or the function of one functional unit may be divided to provide a plurality of functional units. FIG. 2 is a schematic view showing a configuration related to this embodiment, and the server 2 may include functional units other than the functional units shown in FIG. 2.

The notification unit 24 makes various kinds of notifications to the terminal 3 of the user A. The notification unit 24 makes the notifications by the communication I/F of the server 2 via the network N. For example, the notification unit 24 makes a notification about the loan payment state or the like, and if the loan payment delays, makes a notification for promoting payment. The contents of the notifications are decided based on, for example, information held by the acquisition unit 25 or information managed in the database DB. Other than the terminal of the user, the notification unit 24 may make a notification to a predetermined device mounted on the vehicle. For example, the notification unit 24 may instruct the control device 15 via the communication device 16 to display a notification on the meter (described above) of the vehicle 1. Alternatively, an indicator for the above-described notification may be provided on the vehicle 1, and the notification unit 24 may instruct the control device 15 via the communication device 16 of the vehicle 1 to light the indicator. In addition, the notification unit 24 may make a notification to both the terminal 3 and the vehicle 1. In this case, the user can more easily recognize the notification.

The acquisition unit 25 acquires open information representing that the notification that the notification unit 24 has made to the terminal 3 is opened in the terminal 3. It is therefore possible to recognize, on the side of the server 2, that the user A has opened the notification by the notification unit 24. The open information includes, for example, the open date/time, the information of the user A, the information of the vehicle 1 in use, and the like. For example, the terminal 3 is configured to return the open information to the server 2 when the notification received from the server 2 is opened, and the acquisition unit 25 acquires the open information by receiving the open information returned by the processing unit 31 of the terminal 3 to the server 2 via the communication interface unit 33. Also, for example, the acquisition unit 25 requests the open information from the terminal 3 at a predetermined period. If the notification is opened, the terminal 3 transmits the open information as a response to the request, and the acquisition unit 25 acquires the open information.

For example, if the notification unit 24 makes a notification to the terminal 3, and the notification is displayed on the display unit 34 of the terminal 3, the processing unit 31 of the terminal 3 may consider that the notification is opened, and return open information to the server 2. Also, for example, if the notification unit 24 makes a notification to the vehicle 1, it may be considered that the notification is opened when an operation unit mounted in the vehicle 1 is operated. In this case, when the control device 15 of the vehicle 1 transmits the open information to the server via the communication device 16, the acquisition unit 25 can acquire the open information. A notification opening operation may necessarily be performed by inhibiting starting of the power source unless an operation is performed on the operation unit.

The transmission control unit 26 controls transmission of a control signal to the communication unit 16 of the vehicle 1. In this embodiment, the transmission control unit 26 transmits, to the vehicle 1, a signal for requesting restriction of use of the vehicle 1. Also, for example, the transmission control unit 26 transmits a signal for canceling restriction of starting to the vehicle 1 for which the starting of the power source 11 of the vehicle 1 is restricted. Restriction of starting of the vehicle 1 is, for example, stop of starting. When the communication device 16 receives a control signal for stopping starting of the vehicle 1, the control unit 15 controls not to perform starting by the starting device 14 independently of the input of the operation mechanism 13. It is also possible to employ a configuration in which, for example, the control unit 15 controls not to set a key ON (ignition ON) state independently of the input of the operation mechanism 13 to restrict use of the vehicle 1.

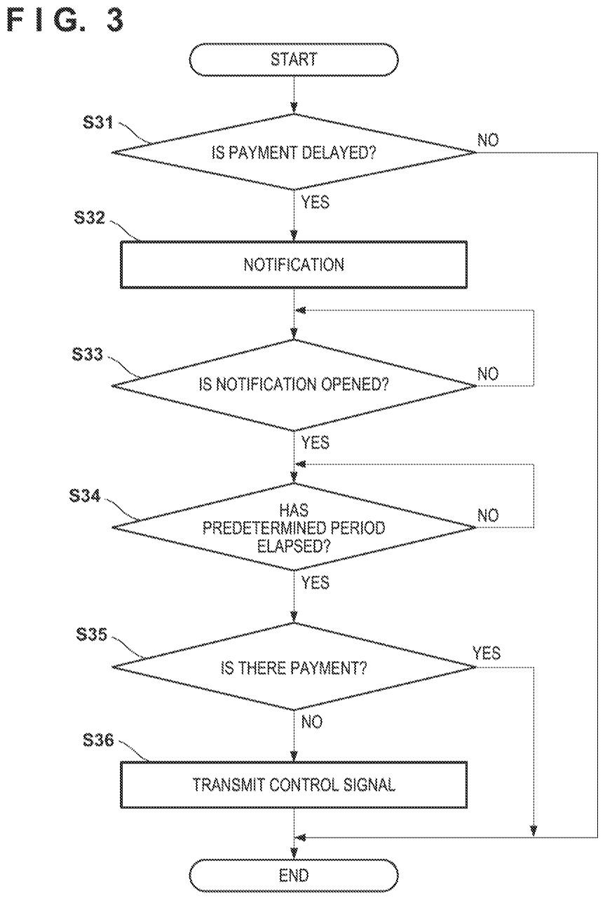

FIG. 3 is a flowchart for explaining an example of remote control of the vehicle 1 by the server 2 according to the first embodiment. This flowchart shows the procedure of restricting, by remote control, use of the vehicle 1 used by the user A whose loan payment has been delayed. For example, if the payment is done monthly, processing based on this flowchart is performed after the elapse of the payment day of each month.

Note that this processing is performed by, for example, the processing unit 21 functioning as the functional units shown in FIG. 2. Here, of the processing shown in FIG. 3, the processes of steps S31 and S32 correspond to processing as the notification unit 24, and step S33 corresponds to processing as the acquisition unit 25. In addition, the processes of steps S36 and S37 correspond to processing as the transmission control unit 26. Note that the correspondence between the functional units and the processes can be changed, and for some of the processes, a functional unit that is not shown in FIG. 2 may perform processing.

In step S31, the processing unit 21 confirms whether payment delay has occurred. If payment delay has not occurred, the processing unit 21 ends the flowchart. If payment delay has occurred, the processing unit 21 advances to the process of step S32. The processing unit 21 performs the confirmation based on information about the user A managed in the database DB of the server 2. In this embodiment, the database DB of the server 2 manages, as the information of the user A, a status concerning payment delay. As an example, a status in a case in which payment delay is not present is “no delay”, and a status in a case in which payment delay exists is “delay”. The processing unit 21 can confirm, by this status, whether payment delay has occurred.

In step S32, the processing unit 21 makes a notification to the terminal 3 of the user A. The processing unit 21 transmits the notification to the terminal 3 by the communication interface 23 via the network N. For example, the processing unit 21 transmits, to the terminal 3, a notification that urges the user A to pay the fee and notifies that if payment is not done, use of the vehicle 1 is restricted. In this embodiment, the processing unit 21 transmits, to the terminal 3, a notification that urges the user to do payment and notifies that if payment is not done, starting of the power source 11 of the vehicle 1 is restricted. After the notification is made, the processing unit 21 changes the status from “delay” to “notified” and advances to the process of step S33. Note that a configuration for making the notification to the vehicle 1 or a configuration for making the notification to both the terminal 3 and the vehicle 1 can also be employed.

In step S33, the processing unit 21 confirms whether the notification is opened in the terminal 3. For example, the processing unit 21 performs the confirmation depending on whether open information is received from the terminal 3. If the notification is not opened, the processing unit 21 repeats the process of step S33. On the other hand, if the notification is opened, the processing unit 21 changes the status from “notified” to “opened” and advances to the process of step S34.

In step S34, the processing unit 21 confirms whether a predetermined period has elapsed from the opening of the notification in the terminal 3. The processing unit 21 performs the confirmation based on the open date/time included in the open information. If the predetermined period has not elapsed, the processing unit 21 repeats the process of step S34. If the predetermined period has elapsed, the processing unit 21 advances to the process of step S35. Here, since the elapse of the predetermined period from the opening of the notification is confirmed, the grace period from the recognition of the fact of payment delay by the user A to the restriction of use of the vehicle 1 can be ensured. That is, it is possible to prevent use of the vehicle 1 from being restricted in a state in which the user does not recognize the fact of payment delay.

In step S35, the processing unit 21 confirms whether payment is done. In this embodiment, the processing unit 21 confirms whether the status is changed from “opened” to “no delay”. If payment is done, the processing unit 21 ends the flowchart. If payment is not done, the processing unit 21 changes the status from “opened” to “use restriction instruction” and advances to the process of step S36. Hence, even if payment delays, the user A can avoid the restriction of use of the vehicle 1 if the payment is done before the elapse of the predetermined period.

In step S36, the processing unit 21 transmits a control signal for restricting use of the vehicle 1, changes the status from “use restriction instruction” to “use restricted”, and ends the flowchart. In this embodiment, the processing unit 21 transmits a control signal for restricting starting of the power source 11 of the vehicle 1. Restriction of starting of the power source is, for example, stop of starting of the power source. The processing unit 21 transmits the control signal to the communication device 16 of the vehicle 1 via the communication interface 23. When the communication device 16 receives the control signal from the server 2, the control device 15 of the vehicle 1 restricts starting of the power source 11 by the starting device 14. This inhibits the user A from using the vehicle 1 until the restriction of starting is canceled.

As described above, according to this embodiment, the notification from the server 2 is opened, and then, use of the vehicle 1 is restricted. Hence, it is possible to restrict use of the vehicle 1 after the user recognizes that the use of the vehicle 1 may be restricted. In addition, since the user never suffers from sudden restriction of use of the vehicle 1, the convenience of the vehicle use service is improved.

Note that in this embodiment, whether payment is done is confirmed after the elapse of a predetermined period from the opening of the notification. However, the confirmation may be performed any time. For example, separately from the flowchart shown in FIG. 3, the processing unit 21 may periodically confirm whether payment is done, and end the flowchart shown in FIG. 3 upon confirming payment.

Also, in this embodiment, the processing unit 21 executes each process of the flowchart shown in FIG. 3 based on the status managed in the database DB. However, each process may be executed based on information that the processing unit 21 has acquired by directly accessing the necessary information on the database DB.

In addition, the timing of restricting starting of the power source 11 by the control unit 15 when the communication device 16 receives the control signal from the server 2 can be adjusted. For example, in a case in which the power source 11 is starting when the control signal is received, immediately restricting the starting of the power source 11 is not preferable in some cases from the viewpoint of ensuring safety for the user A and the periphery. Hence, the vehicle 1 that receives the control signal during starting of the power source 11 may restrict subsequent starting after the starting is stopped.

Furthermore, in this embodiment, starting of the power source 11 is restricted as the restriction of use of the vehicle 1. However, the mode of restriction of use of the vehicle 1 is not limited to this. For example, key ON (ignition ON) may be restricted. Also, for example, a configuration for restricting output of the power source 11 can be employed. In this case, for example, even if use of the vehicle 1 is restricted during driving, the vehicle 1 can be retreated to a safe place without being abruptly stopped. Also, for example, even if use of the vehicle 1 is restricted in a visit place, the vehicle 1 can temporarily be moved to the home or another safe place. At this time, a notification device configured to notify the user A that output of the power source 11 is restricted, such as a warning buzzer or an indicator, may be provided in the vehicle 1. Also, for example, if the communication device 16 receives the control signal from the server 2 during driving, the control unit 15 may gradually restrict output of the power source 11. Furthermore, for example, even if the communication device 16 receives the control signal, normal traveling can be performed for a predetermined distance. Starting of the power source 11 may be restricted after the traveling of the predetermined distance. At this time, the notification device of the vehicle 1 may notify the user A of the remaining travelable distance. Hence, even if restriction of use of the vehicle 1 is started in a visit place, the vehicle 1 can be retreated to the home or another safe place during the time in which traveling is possible.

Furthermore, in this embodiment, the presence/absence of loan payment is set to the condition of restriction of use of the vehicle 1. However, the condition of restriction of use can appropriately be changed. For example, in a rental vehicle, use of the vehicle 1 may be restricted on condition that the vehicle is not returned during the rental period.

### Second Embodiment

In the second embodiment, a configuration in which a server 2 makes a notification to a user stepwise will be described. Note that a description of the same components as in the first embodiment and functions/effects thereof will sometimes be omitted, and components different from in the first embodiment and functions/effects thereof will mainly be described below.

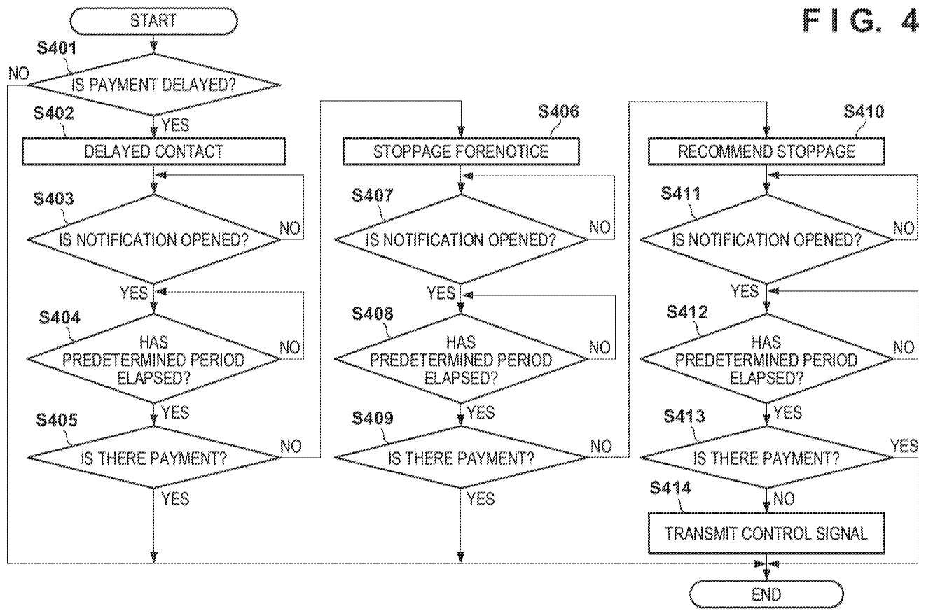

FIG. 4 is a flowchart for explaining an example of remote control of a vehicle 1 by the server 2 according to the second embodiment. In this embodiment, the server 2 makes notifications to a terminal 3 in three steps. If payment cannot be confirmed even after the elapse of a predetermined period from the opening of the notification of the third step, use of the vehicle 1 is restricted. That is, the notifications of the first and second steps are, so to speak, prenotifications. If payment is not performed regardless of a prenotification, a final notification is made as the notification of the third step. If payment is not done yet even if the final notification is made, use of the vehicle 1 is restricted based on a control signal from the server 2. By such stepwise notifications, a user A can grasp stepwise that use of the vehicle 1 may be restricted.

In step S401, a processing unit 21 performs the same processing as in step S31. If payment delay has not occurred, the processing unit 21 ends the flowchart. If payment delay has occurred, the processing unit 21 advances to the process of step S402.

In step S402, the processing unit 21 makes a notification of the first step to the terminal 3 of the user A. The notification of the first step is a notification for notifying that payment delay has occurred. The processing unit 21 transmits the notification to the terminal 3 by a communication interface 23 via a network N. After the transmission of the notification, the processing unit 21 changes the status from “delay” to “first notification transmitted”, and advances to the process of step S403.

In step S403, the processing unit 21 performs the same processing as in step S33. If the first notification is not opened, the processing unit repeats the process of step S403. On the other hand, if the first notification is opened, the processing unit 21 changes the status from “first notification transmitted” to “first notification opened” and advances to the process of step S404.

In step S404, the processing unit 21 performs the same processing as in step S34. If the predetermined period has not elapsed, the processing unit 21 repeats the process of step S404. If the predetermined period has elapsed, the processing unit 21 advances to the process of step S405.

In step S405, the processing unit 21 performs the same processing as in step S35. If payment is done, the processing unit 21 ends the flowchart. That is, the flowchart is ended without making the second and subsequent notifications. If payment is not done, the processing unit 21 advances to the process of step S406.

In step S406, the processing unit 21 makes a notification of the second step to the terminal 3 of the user A. The notification of the second step is a notification for preliminarily announcing that if payment is not done, use of the vehicle 1 is restricted. The processing unit 21 transmits the notification to the terminal 3 by the communication interface 23 via the network N. After the transmission of the notification, the processing unit 21 changes the status from “first notification opened” to “second notification transmitted”, and advances to the process of step S407.

In step S407, the processing unit 21 performs the same processing as in step S403. If the second notification is not opened, the processing unit repeats the process of step S407. On the other hand, if the second notification is opened, the processing unit 21 changes the status from “second notification transmitted” to “second notification opened” and advances to the process of step S408.

In step S408, the processing unit 21 performs the same processing as in step S404. If the predetermined period has not elapsed, the processing unit 21 repeats the process of step S408. If the predetermined period has elapsed, the processing unit 21 advances to the process of step S409. Note that the predetermined period may be the same as or different from the predetermined period in step S404.

In step S409, the processing unit 21 performs the same processing as in step S405. If payment is done, the processing unit 21 ends the flowchart. If payment is not done, the processing unit 21 advances to the process of step S410.

In step S410, the processing unit 21 makes a notification of the third step to the terminal 3 of the user A. The notification of the third step is a notification for recommending the user A to do payment. The processing unit 21 transmits the notification to the terminal 3 by the communication interface 23 via the network N. After the transmission of the notification, the processing unit 21 changes the status from “second notification opened” to “third notification transmitted”, and advances to the process of step S411. Note that as will be described below, the notification of the third step according to the second embodiment corresponds to the notification according to the first embodiment because use of the vehicle 1 is restricted if the user A does not pay even after the arrival of the notification of the third step.

In step S411, the processing unit 21 performs the same processing as in steps S403 and S407. If the third notification is not opened, the processing unit repeats the process of step S411. On the other hand, if the third notification is opened, the processing unit 21 changes the status from “third notification transmitted” to “third notification opened” and advances to the process of step S412.

In step S412, the processing unit 21 performs the same processing as in steps S404 and S408. If the predetermined period has not elapsed, the processing unit 21 repeats the process of step S412. If the predetermined period has elapsed, the processing unit 21 advances to the process of step S413. Note that the predetermined period may be the same as or different from the predetermined period in step S404 or S408.

In step S413, the processing unit 21 performs the same processing as in step S35. If payment is done, the processing unit 21 ends the flowchart. That is, the processing is ended without making the final notification. If payment is not done, the processing unit 21 changes status from “third notification opened” to “use restriction instruction” and advances to the process of step S414.

In step S414, the processing unit 21 transmits a control signal for restricting use of the vehicle 1, changes the status from “use restriction instruction” to “use restricted”, and ends the flowchart. In this embodiment, the processing unit 21 transmits a control signal for restricting starting of a power source 11 of the vehicle 1. The processing unit 21 transmits the control signal to a communication device 16 of the vehicle 1 via the communication interface 23. When the communication device 16 receives the control signal from the server 2, a control device 15 of the vehicle 1 restricts starting of the power source 11 by a starting device 14. This inhibits the user A from using the vehicle 1 until the restriction of starting is canceled.

As described above, according to the second embodiment, the server 2 makes notifications to the user stepwise, and the user A can grasp stepwise that use of the vehicle 1 may be restricted. Note that a configuration in which the processing of the flowchart is ended upon confirming payment from the user A can also be employed, as in the first embodiment.

Also, in this embodiment, notifications of three steps are performed. The steps and the number of times of notifications are not limited to these. For example, the server 2 may make notifications in two steps or in four or more steps. The server 2 may transmit a plurality of notifications until a notification of a certain step is opened. For example, in the status “first notification transmitted”, the processing unit 21 may make a plurality of notifications until the status changes to “first notification opened”. If one of the plurality of notifications is opened, the processing unit 21 may change the status to “first notification opened”. This allows the user A to easily recognize that payment is delayed even if he/she has missed the first notification.

Additionally, for example, use of the vehicle 1 may be restricted stepwise along with the stepwise notifications. For example, the server 2 may transmit a control signal for restricting output of the power source 11 upon making the notification of the third step, and if the notification of the third step is opened, and payment is not done after the elapse of the predetermined period, transmit a control signal for restricting starting of the power source 11. This allows the user A to recognize during driving that payment is delayed even if he/she has opened the notification but not confirmed the contents.

### Third Embodiment

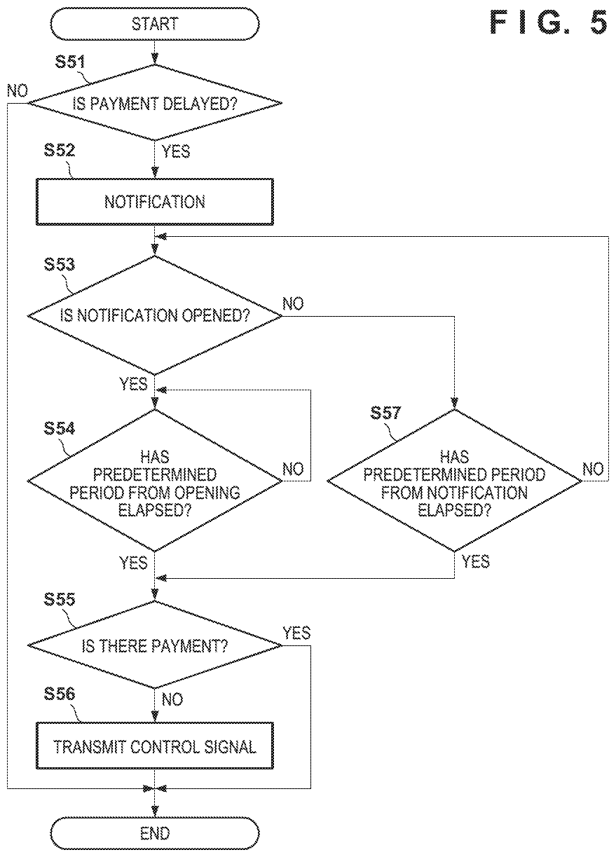

In the first and second embodiments, since use of the vehicle 1 is restricted after the notification from the server 2 is opened, use of the vehicle 1 can be restricted after the user recognizes that use of the vehicle 1 may be restricted. However, in a case in which restriction of use of the vehicle 1 is not done at all until the notification is opened, if the user A leaves the notification or intentionally refrains from opening the notification, the vehicle 1 can continuously be used without payment. In the third embodiment, even if a user A does not open a notification, a server 2 restricts use of the vehicle 1 by remote control after the elapse of a predetermined period. This will be described below with reference to FIG. 5. Note that a description of the same components as in the first embodiment and functions/effects thereof will sometimes be omitted, and components different from in the first embodiment and functions/effects thereof will mainly be described below.

FIG. 5 is a flowchart for explaining an example of remote control of the vehicle 1 by the server 2 according to the third embodiment.

The processes of steps S51 to S56 are the same as the processes of steps S31 to S36. In the first embodiment, however, until it is confirmed in step S33 that the notification is opened, a processing unit 21 repeats the process of step S33. On the other hand, in this embodiment, if it cannot be confirmed in step S53 that the notification is opened, the processing unit 21 advances to the process of step S57.

In step S57, the processing unit 21 determines whether a predetermined period has elapsed after the transmission of the notification in step S52. If the predetermined period has not elapsed, the processing unit 21 returns to the process of step S53. On the other hand, if the predetermined period has elapsed, the processing unit 21 advances to the process of step S55. Hence, even if the notification is not opened, use of the vehicle 1 is restricted after the elapse of the predetermined period. Hence, use of the vehicle 1 can be restricted even if the user A intentionally refrains from opening the notification. Note that the predetermined period in step S54 and the predetermined period in step S57 may be the same or different.

As described above, in this embodiment, even if the user A leaves the notification, use of the vehicle can be restricted. Note that in this embodiment, use of the vehicle 1 is restricted in the same mode in a case in which use of the vehicle 1 is restricted as the result of the elapse of the predetermined period from the opening of the notification and in a case in which use of the vehicle 1 is restricted as the result of the elapse of the predetermined period without the opening of the notification. However, the mode of restriction of use of the vehicle 1 may be changed. For example, in both cases, starting of a power source 11 of the vehicle 1 is stopped. If the notification is not opened, output of the power source 11 may be restricted first, and after the elapse of the predetermined period, starting of the power source may be stopped. According to this configuration, if the user A recognizes that use of the vehicle 1 is to be restricted, the power source 11 can be stopped to disable use of the vehicle 1. On the other hand, if the user A does not recognize that use of the vehicle 1 is to be restricted, output of the power source 11 is restricted first to cause the user A to notice that use of the vehicle 1 is to be restricted, and after that, starting of the power source 11 can be stopped to disable use of the vehicle 1. Hence, even if the notification from the server 2 is not opened, use of the vehicle 1 can be restricted after the user A recognizes it.

### Summary of Embodiments

The above-described embodiments at least disclose the following in-vehicle device.

1. A remote control method for a vehicle according to the above-described embodiment, comprises:

making (for example, S32) a notification to a terminal device;

acquiring (for example, S33) open information representing that the notification is opened in the terminal device; and

controlling (for example, 26) transmission of a control signal for controlling actuation of the vehicle to the vehicle,

wherein in the controlling, the control signal is transmitted based on acquisition of the open information for the notification in the acquiring (for example, S33, S36).

According to this embodiment, use of the vehicle is restricted after the notification from the server is opened. Hence, use of the vehicle can be restricted after the user recognizes that use of the vehicle may be restricted.

2. In the above-described embodiment,

in the controlling, the control signal is transmitted after an elapse of a first period from the acquisition of the open information in the acquiring (for example, S34, S36).

According to this embodiment, the user can ensure the period of grace from confirmation of the notification to the restriction of use of the vehicle.

3. In the above-described embodiment,

in the controlling, if a predetermined condition is satisfied before the elapse of the first period, the control signal is not transmitted (for example, S55).

According to this embodiment, if the predetermined condition is satisfied, and restriction of use of the vehicle is unnecessary, restriction of use can be avoided.

4. In the above-described embodiment,

in the controlling, even if the open information for the notification is not acquired in the acquiring, the control signal is transmitted after an elapse of a second period (for example, S53, S56, S57).

According to this embodiment, even if the user leaves the notification, use of the vehicle can be restricted.

5. In the above-described embodiment,

the notification is a final notification (for example, S410), and

in the making the notification, a predetermined number of times of prenotifications are made (S402, S406) before the final notification.

According to this embodiment, since the predetermined number of times of prenotifications are made before the final notification, the user readily notices the notification.

6. In the above-described embodiment,

in the acquiring, the open information for the prenotification is acquired, and

in the making the notification, a next prenotification is made based on the acquisition of the open information for one prenotification of the predetermined number of times of prenotifications in the acquiring, and the final notification is made based on the acquisition of the open information for a final prenotification of the predetermined number of times of prenotifications in the acquiring.

According to this embodiment, since the server makes stepwise notifications to the user, the user can grasp stepwise that use of the vehicle is to be restricted.

7. In the above-described embodiment,

the predetermined number of times of prenotifications include a first prenotification (for example, S402) for notifying a user of the vehicle that a predetermined condition to use the vehicle is not satisfied, and a second prenotification (for example, S406) for preliminarily announcing that if the predetermined condition is not satisfied, use of the vehicle is restricted,

the final notification is a notification (for example, S410) for recommending the user to satisfy the predetermined condition,

in the making the notification,

the second prenotification is made after an elapse of a third period from the acquisition of the open information for the first prenotification (for example, S403-S406), and

the final notification is made after an elapse of a fourth period from the acquisition of the open information for the second prenotification in the acquiring (for example, S407-S410), and

in the controlling, the control signal is transmitted after an elapse of a fifth period from the acquisition of the open information for the final notification in the acquiring (for example, S411-S414).

According to this embodiment, since the server makes stepwise notifications to the user, the user can grasp stepwise that use of the vehicle is to be restricted.

8. In the above-described embodiment,

in the making the notification, if the predetermined condition is satisfied, next and subsequent prenotifications and the final notification are not made.

According to this embodiment, it is possible to prevent an unnecessary notification from being transmitted to the terminal.

9. In the above-described embodiment,

the control signal is a signal for restricting starting of a power source of the vehicle.

According to this embodiment, starting of the power source of the vehicle is restricted, thereby restricting use of the vehicle.

10. In the above-described embodiment,

the control signal is a signal for restricting output of a power source of the vehicle.

According to this embodiment, output of the power source of the vehicle is restricted, thereby restricting use of the vehicle.

11. In the above-described embodiment,

the vehicle is a straddle type vehicle.

According to this embodiment, it is possible to restrict use of a straddle type vehicle.

12. In the above-described embodiment,

in the making the notification, the notification is further made to the vehicle, and

in the acquiring, the open information is further acquired from the vehicle.

According to this embodiment, it is possible to more reliably cause the user to recognize the notification.

13. A vehicle remote control system (for example, SY) according to the above-described embodiment is

a vehicle remote control system including a server (for example, 2), a vehicle (for example, 1), and a terminal device (for example, 3), wherein

the server comprises:

notification means (for example, 24) for making a notification (for example, S32) to the terminal device;

acquisition means (for example, 25) for acquiring open information representing that the notification is opened in the terminal device; and

transmission control means (for example, 26) for controlling transmission of a control signal for controlling actuation of the vehicle to the vehicle, and

the transmission control unit transmits the control signal based on acquisition of the open information for the notification by the acquisition unit (for example, S33, S36).

According to this embodiment, use of the vehicle is restricted after the notification from the server is opened. Hence, use of the vehicle 1 can be restricted after the user recognizes that use of the vehicle may be restricted.

14. In the above-described embodiment,

the transmission control unit transmits the control signal after an elapse of a first period from the acquisition of the open information by the acquisition unit (for example, S34, S36).

According to this embodiment, the user can ensure the period of grace from confirmation of the notification to the restriction of use of the vehicle.

15. In the above-described embodiment,

if a predetermined condition is satisfied before the elapse of the first period, the transmission control unit does not transmit the control signal (for example, S55).

According to this embodiment, if the predetermined condition is satisfied, and restriction of use of the vehicle is unnecessary, restriction of use can be avoided.

16. In the above-described embodiment,

even if the acquisition unit does not acquire the open information for the notification, the transmission control unit transmits the control signal after an elapse of a second period (for example, S53, S56, S57).

According to this embodiment, even if the user leaves the notification, use of the vehicle can be restricted.

17. In the above-described embodiment,

the notification is a final notification (for example, S410), and

the notification unit makes a predetermined number of times of prenotifications before the final notification (S402, S406).

According to this embodiment, since the predetermined number of times of prenotifications are made before the final notification, the user readily notices the notification.

18. In the above-described embodiment,

the acquisition unit acquires the open information for the prenotification, and

the notification unit makes a next prenotification based on the acquisition of the open information for one prenotification of the predetermined number of times of prenotifications by the acquisition unit, and makes the final notification based on the acquisition of the open information for a final prenotification of the predetermined number of times of prenotifications by the acquisition unit.

According to this embodiment, since the server makes stepwise notifications to the user, the user can grasp stepwise that use of the vehicle is to be restricted.

19. In the above-described embodiment,

the predetermined number of times of prenotifications include a first prenotification (for example, S402) for notifying a user of the vehicle that a predetermined condition to use the vehicle is not satisfied, and a second prenotification (for example, S406) for preliminarily announcing that if the predetermined condition is not satisfied, use of the vehicle is restricted,

the final notification is a notification (for example, S410) for recommending the user to satisfy the predetermined condition,

the notification unit

makes the second prenotification after an elapse of a third period from the acquisition of the open information for the first prenotification (for example, S403-S406), and

makes the final notification after an elapse of a fourth period from the acquisition of the open information for the second prenotification by the acquisition unit (for example, S407-S410), and

the transmission control unit transmits the control signal after an elapse of a fifth period from the acquisition of the open information for the final notification by the acquisition unit (for example, S411-S414).

According to this embodiment, since the server makes stepwise notifications to the user, the user can grasp stepwise that use of the vehicle is to be restricted.

20. In the above-described embodiment,

if the predetermined condition is satisfied, the notification unit does not make next and subsequent prenotifications and the final notification.

According to this embodiment, it is possible to prevent an unnecessary notification from being transmitted to the terminal.

21. In the above-described embodiment,

the control signal is a signal for restricting starting of a power source of the vehicle.

According to this embodiment, starting of the power source of the vehicle is restricted, thereby restricting use of the vehicle.

22. In the above-described embodiment,

the control signal is a signal for restricting output of a power source of the vehicle.

According to this embodiment, output of the power source of the vehicle is restricted, thereby restricting use of the vehicle.

23. In the above-described embodiment,

the vehicle is a straddle type vehicle.

According to this embodiment, it is possible to restrict use of a straddle type vehicle.

24. In the above-described embodiment,

the vehicle comprises an in-vehicle control device (for example, 15) capable of receiving the control signal and capable of controlling actuation of the vehicle based on the received control signal.

According to this embodiment, actuation of the vehicle can be controlled by the in-vehicle control device based on the control signal from the server.

25. In the above-described embodiment,

the notification unit further makes the notification to the vehicle, and

the acquisition unit further acquires the open information from the vehicle.

According to this embodiment, it is possible to more reliably cause the user to recognize the notification.

26. A server (for example, 2) according to the above-described embodiment is

a server capable of transmitting a control signal for remote-controlling a vehicle, wherein

the server comprises:

notification means (for example, 24) for making a notification (for example, S32) to a terminal device;

acquisition means (for example, 25) for acquiring open information representing that the notification is opened in the terminal device; and

transmission control means (for example, 26) for controlling transmission of a control signal for controlling actuation of the vehicle to the vehicle, and

the transmission control unit transmits the control signal based on acquisition of the open information for the notification by the acquisition unit (for example, S33, S36).

According to this embodiment, use of the vehicle is restricted after the notification from the server is opened. Hence, use of the vehicle 1 can be restricted after the user recognizes that use of the vehicle may be restricted.

27. In the above-described embodiment,

the transmission control unit transmits the control signal after an elapse of a first period from the acquisition of the open information by the acquisition unit (for example, S34, S36).

According to this embodiment, the user can ensure the period of grace from confirmation of the notification to the restriction of use of the vehicle.

28. In the above-described embodiment,

if a predetermined condition is satisfied before the elapse of the first period, the transmission control unit does not transmit the control signal (for example, S55).

According to this embodiment, if the predetermined condition is satisfied, and restriction of use of the vehicle is unnecessary, restriction of use can be avoided.

29. In the above-described embodiment,

even if the acquisition unit does not acquire the open information for the notification, the transmission control unit transmits the control signal after an elapse of a second period (for example, S53, S56, S57).

According to this embodiment, even if the user leaves the notification, use of the vehicle can be restricted.

30. In the above-described embodiment,

the notification is a final notification (for example, S410), and

the notification unit makes a predetermined number of times of prenotifications before the final notification (S402, S406).

According to this embodiment, since the predetermined number of times of prenotifications are made before the final notification, the user readily notices the notification.

31. In the above-described embodiment,

the acquisition unit acquires the open information for the prenotification, and

the notification unit makes a next prenotification based on the acquisition of the open information for one prenotification of the predetermined number of times of prenotifications by the acquisition unit, and makes the final notification based on the acquisition of the open information for a final prenotification of the predetermined number of times of prenotifications by the acquisition unit.

According to this embodiment, since the server makes stepwise notifications to the user, the user can grasp stepwise that use of the vehicle is to be restricted.

32. In the above-described embodiment,

the predetermined number of times of prenotifications include a first prenotification (for example, S402) for notifying a user of the vehicle that a predetermined condition to use the vehicle is not satisfied, and a second prenotification (for example, S406) for preliminarily announcing that if the predetermined condition is not satisfied, use of the vehicle is restricted,

the final notification is a notification (for example, S410) for recommending the user to satisfy the predetermined condition,

the notification unit

makes the second prenotification after an elapse of a third period from the acquisition of the open information for the first prenotification (for example, S403-S406), and

makes the final notification after an elapse of a fourth period from the acquisition of the open information for the second prenotification by the acquisition unit (for example, S407-S410), and

the transmission control unit transmits the control signal after an elapse of a fifth period from the acquisition of the open information for the final notification by the acquisition unit (for example, S411-S414).

According to this embodiment, since the server makes stepwise notifications to the user, the user can grasp stepwise that use of the vehicle is to be restricted.

33. In the above-described embodiment,

if the predetermined condition is satisfied, the notification unit does not make next and subsequent prenotifications and the final notification.

According to this embodiment, it is possible to prevent an unnecessary notification from being transmitted to the terminal.

34. In the above-described embodiment,

the control signal is a signal for restricting starting of a power source of the vehicle.

According to this embodiment, starting of the power source of the vehicle is restricted, thereby restricting use of the vehicle.

35. In the above-described embodiment,

the control signal is a signal for restricting output of a power source of the vehicle.

According to this embodiment, output of the power source of the vehicle is restricted, thereby restricting use of the vehicle.

36. An in-vehicle control device (for example, 15) according to the above-described embodiment

can receive a control signal from the server (for example, 2) according to the above-described embodiment and control actuation of a vehicle (for example, 1) based on the received control signal.

According to this embodiment, there is provided an in-vehicle control device capable of controlling a vehicle based on a control signal from a server.

37. A vehicle (for example, 1) according to the above-described embodiment

comprises an in-vehicle control device (for example, 15) according to the above-described embodiment.

According to this embodiment, there is provided a vehicle including an in-vehicle control device.

38. A terminal device (for example, 3) according to the above-described embodiment is

a terminal device capable of receiving a notification from the server according to the above-described embodiment, characterized by comprising:

reception means (for example, 31) for receiving the notification from the server;

display means (for example, 34) capable of displaying the notification; and

transmission means (for example, 31) for, if the display unit displays the notification, transmitting, to the server, open information representing that the notification is opened.

According to this embodiment, there is provided a terminal device capable of transmitting open information to a server.

The invention is not limited to the foregoing embodiments, and various variations/changes are possible within the spirit of the invention.

What is claimed is:

1. A remote control method for a vehicle comprising:
making a notification to a terminal device;
acquiring open information representing that the notification is opened in the terminal device; and
controlling transmission of a control signal for controlling actuation of the vehicle to the vehicle,
wherein in the controlling, the control signal is transmitted based on acquisition of the open information for the notification in the acquiring, and
wherein the control signal is a signal for restricting starting of a power source of the vehicle.

2. The remote control method according to claim 1, wherein in the controlling, the control signal is transmitted after an elapse of a first period from the acquisition of the open information in the acquiring.

3. The remote control method according to claim 2, wherein in the controlling, if a predetermined condition is satisfied before the elapse of the first period, the control signal is not transmitted.

4. The remote control method according to claim 2, wherein in the controlling, even if the open information for the notification is not acquired in the acquiring, the control signal is transmitted after an elapse of a second period.

5. The remote control method according to claim 1, wherein
the notification is a final notification, and
in the making the notification, a predetermined number of times of prenotifications are made before the final notification.

6. The remote control method according to claim 5, wherein in the acquiring, the open information for the prenotification is acquired, and
wherein in the making the notification, a next prenotification is made based on the acquisition of the open information for one prenotification of the predetermined number of times of prenotifications in the acquiring, and the final notification is made based on the acquisition of the open information for a final prenotification of the predetermined number of times of prenotifications in the acquiring.

7. The remote control method according to claim 6, wherein the predetermined number of times of prenotifications include a first prenotification for notifying a user of the vehicle that a predetermined condition to use the vehicle is not satisfied, and a second prenotification for preliminarily announcing that if the predetermined condition is not satisfied, use of the vehicle is restricted,
wherein the final notification is a notification for recommending the user to satisfy the predetermined condition,
wherein in the making the notification,
the second prenotification is made after an elapse of a third period from the acquisition of the open information for the first prenotification, and
the final notification is made after an elapse of a fourth period from the acquisition of the open information for the second prenotification in the acquiring, and
wherein in the controlling, the control signal is transmitted after an elapse of a fifth period from the acquisition of the open information for the final notification in the acquiring.

8. The remote control method according to claim 7, wherein in the making the notification, if the predetermined condition is satisfied, next and subsequent prenotifications and the final notification are not made.

9. The remote control method according to claim 1, wherein the vehicle is a straddle type vehicle.

10. The remote control method according to claim 1, wherein in the making the notification, the notification is further made to the vehicle, and
wherein in the acquiring, the open information is further acquired from the vehicle.

11. A vehicle remote control system comprising a server, a vehicle, and a terminal device, wherein the server comprises:
a notification unit configured to make a notification to the terminal device;
an acquisition unit configured to acquire open information representing that the notification is opened in the terminal device; and
a transmission control unit configured to control transmission of a control signal for controlling actuation of the vehicle to the vehicle,
wherein the transmission control unit transmits the control signal based on acquisition of the open information for the notification by the acquisition unit, and
wherein the control signal is a signal for restricting starting of a power source of the vehicle.

12. The vehicle remote control system according to claim 11, wherein the transmission control unit transmits the control signal after an elapse of a first period from the acquisition of the open information by the acquisition unit.

13. The vehicle remote control system according to claim 12, wherein if a predetermined condition is satisfied before the elapse of the first period, the transmission control unit does not transmit the control signal.

14. The vehicle remote control system according to claim 13, wherein even if the acquisition unit does not acquire the open information for the notification, the transmission control unit transmits the control signal after an elapse of a second period.

15. The vehicle remote control system according to claim 11, wherein the notification is a final notification, and
wherein the notification unit makes a predetermined number of times of prenotifications before the final notification.

16. The vehicle remote control system according to claim 15, wherein the acquisition unit acquires the open information for the prenotification, and
wherein the notification unit makes a next prenotification based on the acquisition of the open information for one prenotification of the predetermined number of times of prenotifications by the acquisition unit, and makes the final notification based on the acquisition of the open information for a final prenotification of the predetermined number of times of prenotifications by the acquisition unit.

17. The vehicle remote control system according to claim 16, wherein the predetermined number of times of prenotifications include a first prenotification for notifying a user of the vehicle that a predetermined condition to use the vehicle is not satisfied, and a second prenotification for preliminarily announcing that if the predetermined condition is not satisfied, use of the vehicle is restricted,
wherein the final notification is a notification for recommending the user to satisfy the predetermined condition,
wherein the notification unit
makes the second prenotification after an elapse of a third period from the acquisition of the open information for the first prenotification, and
makes the final notification after an elapse of a fourth period from the acquisition of the open information for the second prenotification by the acquisition unit, and
wherein the transmission control unit transmits the control signal after an elapse of a fifth period from the acquisition of the open information for the final notification by the acquisition unit.

18. The vehicle remote control system according to claim 17, wherein if the predetermined condition is satisfied, the notification unit does not make next and subsequent prenotifications and the final notification.

19. The vehicle remote control system according to claim 11, wherein the vehicle is a straddle type vehicle.

20. The vehicle remote control system according to claim 11, wherein the vehicle comprises an in-vehicle control device capable of receiving the control signal and capable of controlling actuation of the vehicle based on the received control signal.

21. The vehicle remote control system according to claim 11, wherein the notification unit further makes the notification to the vehicle, and
wherein the acquisition unit further acquires the open information from the vehicle.

22. A server capable of transmitting a control signal for remote-controlling a vehicle comprising:
a notification unit configured to make a notification to a terminal device;
an acquisition unit configured to acquire open information representing that the notification is opened in the terminal device; and
a transmission control unit configured to control transmission of a control signal for controlling actuation of the vehicle to the vehicle,
wherein the transmission control unit transmits the control signal based on acquisition of the open information for the notification by the acquisition unit, and
wherein the control signal is a signal for restricting starting of a power source of the vehicle.

23. The server according to claim 22, wherein the transmission control unit transmits the control signal after an elapse of a first period from the acquisition of the open information by the acquisition unit.

24. The server according to claim 23, wherein if a predetermined condition is satisfied before the elapse of the first period, the transmission control unit does not transmit the control signal.

25. The server according to claim 22, wherein even if the acquisition unit does not acquire the open information for the notification, the transmission control unit transmits the control signal after an elapse of a second period.

26. The server according to claim 22, wherein the notification is a final notification, and
wherein the notification unit makes a predetermined number of times of prenotifications before the final notification.

27. The server according to claim 26, wherein the acquisition unit acquires the open information for the prenotification, and
wherein the notification unit makes a next prenotification based on the acquisition of the open information for one prenotification of the predetermined number of times of prenotifications by the acquisition unit, and makes the final notification based on the acquisition of the open information for a final prenotification of the predetermined number of times of prenotifications by the acquisition unit.

28. The server according to claim 27, wherein the predetermined number of times of prenotifications include a first prenotification for notifying a user of the vehicle that a predetermined condition to use the vehicle is not satisfied, and a second prenotification for preliminarily announcing that if the predetermined condition is not satisfied, use of the vehicle is restricted,
wherein the final notification is a notification for recommending the user to satisfy the predetermined condition,
wherein the notification unit
makes the second prenotification after an elapse of a third period from the acquisition of the open information for the first prenotification, and
makes the final notification after an elapse of a fourth period from the acquisition of the open information for the second prenotification by the acquisition unit, and
wherein the transmission control unit transmits the control signal after an elapse of a fifth period from the acquisition of the open information for the final notification by the acquisition unit.

29. The server according to claim 28, wherein if the predetermined condition is satisfied, the notification unit does not make next and subsequent prenotifications and the final notification.

30. An in-vehicle control device wherein the device can receive a control signal from a server defined in claim 26 and control actuation of a vehicle based on the received control signal.

31. A vehicle comprising an in-vehicle control device defined in claim 30.

32. A terminal device capable of receiving a notification from a server defined in claim 22 comprising:
a reception unit configured to receive the notification from the server;
a display unit configured to be capable of displaying the notification; and
a transmission unit configured to, if the display unit displays the notification, transmit, to the server, open information representing that the notification is opened.

33. A remote control method for a vehicle comprising:
making a notification to a terminal device;
acquiring information representing that the notification is displayed on a display unit of the terminal device; and
controlling transmission of a control signal for controlling actuation of the vehicle to the vehicle,
wherein in the controlling, the control signal is transmitted based on acquisition of the information representing that the notification is displayed in the acquiring, and
wherein the control signal is a signal for restricting starting of a power source of the vehicle.

34. A vehicle remote control system comprising a server, a vehicle, and a terminal device,
wherein the server comprises:
a notification unit configured to make a notification to the terminal device;
an acquisition unit configured to acquire information representing that the notification is displayed on a display unit of the terminal device; and
a transmission control unit configured to control transmission of a control signal for controlling actuation of the vehicle to the vehicle,
wherein the transmission control unit transmits the control signal based on acquisition of the information representing that the notification is displayed by the acquisition unit, and
wherein the control signal is a signal for restricting starting of a power source of the vehicle.

35. A server capable of transmitting a control signal for remote-controlling a vehicle comprising:
a notification unit configured to make a notification to a terminal device;
an acquisition unit configured to acquire information representing that the notification is displayed on a display unit of the terminal device; and
a transmission control unit configured to control transmission of a control signal for controlling actuation of the vehicle to the vehicle,
wherein the transmission control unit transmits the control signal based on acquisition of the information representing that the notification is displayed by the acquisition unit, and
wherein the control signal is a signal for restricting starting of a power source of the vehicle.
